(19) United States
(12) Patent Application Publication
(10) Pub. No.: US 2018/0341919 A1
(43) Pub. Date: Nov. 29, 2018

(54) SYSTEM AND METHOD FOR INVITATION MECHANISMS TO FACILITATE ASSOCIATE DELIVERY OF PRODUCTS EN ROUTE FROM WORK

(71) Applicant: Walmart Apollo, LLC, Bentonville, AR (US)

(72) Inventors: Austin Luhman, Bloomfield, NJ (US); Nathan T. Faust, Bentonville, AR (US); Jacob Hipps, Bentonville, AR (US); Tony Kimani, Bentonville, AR (US)

(73) Assignee: Walmart Apollo, LLC, Bentonville, AR (US)

(21) Appl. No.: 15/989,801

(22) Filed: May 25, 2018

Related U.S. Application Data
(60) Provisional application No. 62/511,260, filed on May 25, 2017.

(51) Int. Cl. G06Q 10/08; G01C 21/34

(52) U.S. Cl. CPC G06Q 10/08355; G01C 21/3407

(57) ABSTRACT

System, method, and computer-readable storage media which facilitate associate delivery of products while en route from work. More specifically, the system is receiving an online order for a product, forwarding the product from a fulfillment center to a retail store, then inviting the retail store employees/associates to deliver the product on their commute home. In this manner the business can pay store associates who wish to receive additional income while minimizing delivery costs.

### BACKGROUND

### 1. Technical Field

The present disclosure relates to product delivery systems, and more specifically to mobile application and backend computing services which enable associates, such as store employees, to volunteer to deliver products to customers en route from work.

### 2. Introduction

With online sales, businesses have the additional expense of delivery costs to deliver the product to the customer's home. Services such as Federal Express (FedEx), United Parcel Service (UPS), and the U.S. Postal Service can cost those businesses billions of dollars each year. In some cases, such as a company which operates entirely online (i.e., no brick-and-mortar locations), the company may have no option other than to utilize a delivery service such as FedEx or UPS. However, for companies which operate both online and maintain brick-and-mortar locations, alternative delivery options are available.

### SUMMARY

An exemplary method for inviting associates to deliver packaged products en route to their homes after work can include: receiving, on a mobile device associated with an employee, an employee registration for the employee, wherein the employee registration includes a home address of the employee; transmitting the employee registration to a server; receiving, from the server, a list of packages for delivery, the list of packages based at least in part on distances of packages in the list of packages from a route, the route being between a place of employment of the employee where the packages are stored and the home address; displaying, via the mobile device, the list of packages, wherein each package in the list of packages is displayed with a time required to deliver the package, a wage for delivering the package, a travel distance required to deliver the package, and an option to accept responsibility for delivering the package; receiving, at the mobile device, an input from the employee indicating a specific package in the list of packages which the employee will deliver; transmitting, from the mobile device to the server, the input; receiving, from the server, an updated list of packages, wherein the updated list of packages is modified based on an updated route of the employee, the updated route reflecting delivery of the specific package by the employee while en route to the home address of the employee.

An exemplary system configured as disclosed herein can include: a processor; and a computer-readable storage medium having instructions stored which, when executed by the processor, cause the processor to perform operations comprising: receiving, from a mobile device associated with an employee, an employee registration, the employee registration identifying a home address of the employee; identifying a place of employment of the employee; generating an employee travel route between the place of employment and the home address of the employee; identifying packages stored at the place of employment which are to be delivered to customers, each package having a delivery address; calculating, for each package in the packages, an added commute time for the employee to deliver the each package to the delivery address of the each package while en route from the place of employment to the home address via the employee travel route, to yield calculated added commute times; generating, based on the calculated added commute times, a list of a top n packages, the top n packages representing a number of the packages having shortest added commute times; and transmitting the list of the top n packages to the mobile device, wherein the mobile device presents the list of top n packages as offers for the employee to deliver one or more of the top n packages to respective delivery addresses of the top n packages.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates exemplary cost savings available through the disclosed concepts;

FIGS. 2A and 2B illustrate an exemplary delivery route an associate can take to delivery products while en route to their home;

FIG. 3 illustrates exemplary stages of product fulfillment;

FIG. 4 illustrates exemplary processes being performed by an application operating on a mobile device and processes being performed simultaneously by backend computers supporting the application;

FIGS. 5A and 5B illustrate an exemplary flow chart of a successful delivery by a store associate;

FIG. 6 illustrates an exemplary method embodiment; and

FIG. 7 illustrates an example computer system.

### DETAILED DESCRIPTION

System, method, and computer-readable storage media are disclosed which facilitate associate delivery of products while en route from work. More specifically, disclosed herein are mechanisms for receiving an online order for a product, forwarding the product from a fulfillment center to a retail store, then inviting the retail store employees/associates to deliver the product on their commute home. In this manner the business can pay store associates who wish to receive additional income while minimizing delivery costs.

Consider the following examples. In a first case, an online order is placed with an online vendor for a product. An order system receives the online order and identifies the ordered product within a fulfillment center, which packages the product for delivery, and provides the product to a delivery service such as Federal Express (FedEx), United Parcel Service (UPS), or the U.S. Postal Service (U.S.P.S.). In this example, assume the cost for a delivery service to deliver the packaged product to the customer is $6. In a second case, the online order is again received by the fulfillment center, which packages the product for delivery. However, in this case, the packaged product is transported by truck (or train, or other transportation mechanism) to a retail store associated with the online vendor. The exemplary cost for such transportation to the retail store is $0.82. The retail store receives the packaged product and places it into a storage location at a cost of $0.63 (to unload the truck and move the product to the storage area).

At this point, a computing system configured as described herein identifies store associates who have registered to deliver products after their shifts ends at the retail store. The computing system compares the delivery location of the packaged product (and other packaged products received and stored in the storage area) to the end destination of the registered employees. If the route an associate takes from the store their end destination is within a threshold tolerance, the system can offer the associate the ability to deliver the packaged product in exchange for a predefined amount of money. For example, the system may offer the associate $2 per package delivered. The associate can then look at the deliveries being offered, the amount of time each such delivery would take (the time being calculated by the system based on the associate's current route home and other deliveries already accepted), the money offered for each respective delivery, and select which deliveries (if any) they wish to accept. In this example, if the truck delivery from the fulfillment center to the retail location costs $0.82, the labor to store the packaged product at the retail location costs $0.63, and the cost to the associate for delivery of the package to the customer costs $2.00, the total cost is $3.45, a savings of $3.55 over the $6 a delivery service requires. This puts money into the hands of the company's employees, rather than paying for a premium delivery service.

At the same time, the system can be configured to use a delivery service (such as FedEx, UPS, or USPS) when no associates volunteer to deliver a package. This “backup” or exception system ensures that the package is still be timely delivered, even if none of the store associates invited to deliver the package accept the invitation.

When associates/store employees register to deliver packages from the retail locations to the customers, the associates can specify their home (or other location they travel to after work), their mode of transportation (bike, car, bus, etc.), the size/weight of packages they are willing to carry, the types of packages they are willing to transport, the maximum number of packages they are willing to transport at any one time, and/or other preferences.

In some configurations, the associates can be paid on a per-package basis, such as described above. In other configurations, the associates can be paid based on their normal hourly wage. In yet other configurations, the system can provide the higher of the two options to the associates, thereby guaranteeing that the associates will make “at least” their normal wage, if not significantly more.

To volunteer, the associate can use an application on their personal mobile device (such as a smartphone or tablet), or on a mobile device provided by the retailer. The associate enters identifying information, such as name, phone number, email address, employee number, etc. The associate can also enter information about where the associate typically travels after work, such as their home address or other location. The associate can similarly enter when that trip home happens (i.e., when their shift ends). Alternatively, the associate's shift information can be obtained from a schedule database maintained by the retailer. The associate can also enter information regarding the size, weight, and/or number of packages they feel comfortable delivering. This information may be updated by the associate as needed.

Servers communicating with the mobile application receive this data and calculate a route the associate likely takes to travel home. As packages are received at the retail location (or, in some configurations, at other points in the supply chain) the servers identify associates at the retail location who have volunteered to deliver packages. The servers then compare the routes taken by the associates to their homes to the delivery locations of the packaged products, calculating the additional time/distance required for the associate to make the delivery of each received package.

The servers then communicate this information to the application on the associate's mobile device, such that the associate can view available packages which need to be delivered, along with the amount of money being offered to do the delivery, the amount of additional time/distance required to make the delivery. When an associate accepts to perform a delivery of a package via a mobile device, the mobile device sends a notification of that acceptance to the backend system, which in turn updates the mobile devices of other associates so that the package is removed from the offerings of other associates. In addition, the stored route for that associate is updated for that day, allowing the system to recalculate what additional packages need to be delivered within a threshold distance/time of the updated route, then offering those additional packages to the associate. In this manner, the packages being offered to the associate, via the mobile application, can constantly change based on (1) the associate's route home changing as the associate volunteers to make deliveries and (2) other associates volunteer to deliver packages.

In some configurations, the associates can provide the amount of time they have available for making deliveries after work, and the system can make suggestions based on that additional factor. For example, if the associate indicates that they have an extra 10 minutes, the system can suggest deliveries which fit within that 10 minute window. In addition, in some configurations the system can offer bundled/clustered deliveries. For example, if there are multiple deliveries to be made within a close radius, the system can suggest, via the application, that an associate volunteer to deliver the bundle. Likewise, if the user has indicated they have a time limit, the system can suggest multiple packages for delivery which would together fit within the specified time limit.

The number of associates to whom the delivery invitation is given can be limited by the system. For example, the system may limit the number of invitations to deliver a package to five outstanding invitations at any one time. As associates turn down the invitation, other associates (who may be less ideal based on their routes, ranking, previous performance, specialty, etc.) can be invited. In other cases, the system may increase this limit based on an amount of time since an initial invitation, rejections of the offer, etc. For example, if the invitation to make the delivery was originally extended to two associates and both associates turn down the offer, the system may subsequently offer the delivery to four different/new associates. If the system changes terms associated with the delivery due to rejection, the new delivery terms may be presented as a new delivery job. For example, if the system presented a delivery task for $5 which was turned down by three associates, the system may determine that a higher incentive may be required to deliver the package. If the system likewise determines that a cost savings would still occur at a slightly higher delivery price (such as $5.50 or $6), the system can present that new price to new associates and/or the three associates who already turned down the delivery job.

The associates selected by the system for a delivery offer can be identified based on predefined criteria for which the associates represent the best current options of registered associates. For example, the system can calculate the incremental time/distance required by a particular associate to deliver a given package based on their pre-existing route, then select those associates with the minimum incremental time as those which receive the offers. Other mechanisms which can be implemented to determine which associates receive delivery invitations can include past performance, specialties, acceptance rates (i.e., rewarding those associates who consistently accept take delivery jobs), and the overall cost to the delivery network (which can be calculated in currency and/or time to delivery).

In some cases, the system can identify potential associates to perform a delivery based on constraints specific to an associate, such as the location of the associate's home, working hours, vehicle size, package weight/capability of the associate, etc. In other cases, the system can ease those constraints. For example, if the system is unable to find an associate to deliver a package due to location-based constraints, the system can ease those location restraints. In such a scenario, store associates may choose to deliver a package after their shift, despite the package delivery location not being on the way home.

Another exemplary way in which the system may ease constraints can include hours, such that if a store associate wants to deliver packages at times unrelated to their shift, the system can relax the constraint that associate's offered the option of delivery should be working at the store. This effectively allows the store associate to take on a second job performing deliveries, or operate as a flexible contractor outside of their required shift. Yet another exemplary way in which constraints can be modified can be regarding the weight requirements of a package. If the package weighs more than the capability of a single user, the system may send invitations to deliver the package to pairs of associates, such that the pair of associates can pick up and move the package together. In such cases, some configurations may require both associates individually respond, or may require that a representative of the pair of associates respond. In some cases, rather than sending the invitation to a pair, the system may send the invitation to a single associate, then ask the store associate who accepts the job to select from additional, available associates which associates should receive the offer to deliver the package as part of a delivery pair.

Once an associate has accepted one or more delivery offers, the associate may continue working in the retail location until their shift is complete, at which point the application can remind the associate to proceed to the storage area and pick up the packages for delivery. A self-service or manned check out station may be provided at the storage area. The packages may have labels which are scanned or the packages are otherwise checked out to the associate. A quality control process may also be employed to ensure the packages are in good condition. The associate clocks out, or otherwise completes their shift, and takes the packages to their personal vehicle. The application then provides directions for the associate to arrive at the delivery locations. That is, the application operates as a GPS guidance system for the associate, so that the associate can drive to the delivery locations on the most efficient route. Upon arriving, the associate delivers the package, the application moves to the next package and provides additional direction, and continues in this manner until the assigned packages are delivered. If the associate cannot find the delivery destination, they may enter this information into the app. The system may then locate ad route the associate to the nearest location for another courier, such as a pick-up location for a commercial courier. The system updates the relevant databases accordingly.

During the delivery process, the application can receive confirmation of delivery by accepting a signature from the customer receiving the package. Alternatively, if the customer is not home, the application can be used to take a picture of the package on the porch of the customer. The application can then forward the signature or the picture to the system/servers, which in turn can update the package status and send the customer a receipt containing the signature or picture. The application can also show the remaining routes/deliveries which need to be completed, records of routes/earning for past deliveries, ratings or feedback regarding the associate who delivered the package.

The system can match packages to be delivered with potential associates that can deliver the packages. The system may manage the associate's preferences and the information regarding the package. The system may determine the delivery route for the packages and the potential earnings for the associate. This information may be displayed to the associate via the app as described above. As the associate selects or declines the packages available for delivery, the route and potential earnings may be updated.

The system may include a courier database that stores the information regarding the courier, such as a store associate, and the associate's preferences. This information may be entered via the app, an in-store kiosk or other method. The information may include the associate's typical route when leaving the store, departure time, and their delivery preferences. The courier database may also store an updated route if the associate varies their usual after work destination, for example visiting family, walking home versus driving, etc.

A delivery database may also be provided to manage data regarding the delivery of packages. The delivery database may be a stand-alone database, part of an inventory management system and/or incorporated with the courier database. The courier database may be similarly configured. The delivery database may store information regarding the packages available for delivery from a location, such as respective retail stores. The database may include the package's size, weight, delivery date, destination and the like. The system may update the database as the delivery progresses to include information regarding the delivery, as is described in more detail below.

When an on-line order is received, a pool of packages eligible for the associate delivery process are identified. The packages may be provided to the retail store from the fulfillment center, other location or may originate from the store's existing inventory. The delivery database is provided with information regarding the packages available for delivery from the retail store as noted above. Packages may be assigned to a retail store for associate delivery based on predetermined criteria. The criteria may include the distance and/or time the delivery destination is from the store, the store is in the same zip code or other geographic area and the store, etc. Packages bound for delivery destinations that are outside of the criteria or a selected radius, such as 10 miles, may not be considered for associate delivery from the store.

Once the pool of packages available for delivery from the store is identified, the packages are matched with that store's associates that are potential couriers for the package. Embodiments of the invention leverage existing store employees and their commutes or other travel from the store for delivery. Packages are tied to employees who are already on the way towards the delivery destination for the package, resulting in little to no incremental time, costs or effort associated with the delivery. Experiments of embodiments of the present invention have resulting in increased customer satisfaction. Net promoter scores for packages delivered using an experimental model for the invention have increased by double digits over prior methods.

The matching may be based on the incremental time or distance that the delivery adds to the associate's usual travel. In an example, each package is matched with one or more associates that have a minimum deviation from the respective associate's reported route from the store. The courier database stores the associates' routes and the time the associates leave the store. The delivery destination and deadline for each package may be retrieved from the databases and compared to each associate's route. Those associates that have routes near the delivery destination for the package may be matched to that package. The associates may be ranked based on the minimum deviation from their usual route to deliver the package. A predetermined number of associates, for example, five with the lowest deviations, may be presented with the option of delivering the package. Alternatively, those associates with a deviation below a threshold may be selected. The threshold may be based on time, distance or other desired criteria. The packages are put in a queue for the matched associates and presented to the associates via the app for selection for delivery. Once a set of associates is determined, the routes for those respective associates to deliver the packages may be determined.

The system may compare the package information from the delivery database with the courier information from the courier database to determine associates that are potential couriers. For example, the package's size, weight, etc. are matched with associate's information to find matches and eliminate others. This may be done before, after or in place of the incremental time/distance determination, or not at all.

More specifically, the associates may be matched with packages based on time, distance, cost to deliver the package, and the associate's rate of acceptance of deliveries. These criteria may be weighted and arranged in any sub-combination. For example, if the time is of the essence, perhaps due to a delivery deadline, the time factor may be weighted more heavily.

In another example, the system may determine that a number of packages may be clustered in the same delivery vicinity. For example, four packages may be queued for delivery on the same block. The system may determine that a larger deviation from the associates' routes may be acceptable due to economies of scale in delivering the larger number of packages in a small area. The cost of delivery may make it advisable to accommodate a larger deviation in such a case of a dense cluster of deliveries.

The incremental time or distance traveled by the associate for the delivery may be multiplied by the delivery fee to determine a wage for the delivery. For example, if the delivery fee paid to the associate for the delivery is $2 and the incremental time added to their travel time is 6 minutes, the effective wage for the delivery may be $2/0.1 hours=$20 per hour.

The delivery fee paid to the associate may be based on a number of factors. These factors may include time, miles traveled, or a combination of the two. For example, the delivery fee may be based on the entire distance from the store to the last delivery or the associate's end destination, the incremental distance traveled, the associate's wage for the incremental time taken to deliver the packages or the entire time taken for the deliveries, or until the associate reaches their end destination. The fee may also be a fixed fee on a per package or group of package basis.

The fee, route and incremental time and distance for each package may be determined and presented to the associate via the app as noted above. The packages selected for delivery by the associate are received by the system from the app via an API. Once a package is selected by an associate, the delivery database is updated and that package is removed from the queues for other associates. Associates may also indicate that they are not interested in delivering a package via the app. The system receives a notice from the app for each package declined by the associate and updates the database reflecting the same. The system may then offer the package to additional associates. For example, each time the package is declined, the package may be offered to the next one, two or other selected number of associates in the queue. Further, the package may have a number of associates that it should be offered to and the system may update the offers to maintain this number. These re-offers may occur until the package is accepted for delivery or routed for exception handling.

For packages that are not selected by an associate for delivery, delivery may be arranged via other means, such as a commercial carrier. Packages may be queued for other delivery means if a predetermined number of associates decline the package, a cut-off time for the other delivery method is under a threshold, the estimated delivery time is approaching, etc.

The system may also push a notification to the associate that they have packages to be picked up for delivery. At a designated time, the associate retrieves the packages selected for delivery and checks them out. The delivery and courier databases may be updated to reflect that the associate has the packages and that the packages are en route. The system may send a notification to the customer to update the customer of the delivery status.

The system communicates with the mobile device to provide the delivery route to the associate and tracks the associate's progress in delivering the packages. A mapping API may be used to accomplish this. The route for the first delivery is determined and presented to the associate via the app. The location received from the mobile device may be matched with the delivery location from the delivery database to ensure the package is delivered to the proper destination. Address and other information may be presented to the associate via the app to confirm the delivery destination. Confirmation may be requested.

Once the delivery is completed, the system receives the delivery verification information from the app and updates the databases to reflect the delivery, for example storing the delivery date, time and location. The verification information such as the customer signature or a picture may also be stored. The delivery verification information may be provided to the customer, for example in a notification email or text message. Once the delivery is verified, the system may also initiate payment to the associate of the delivery fee. The system may integrate with accounting and human resources system to this end.

If there are other packages for delivery, the system sends a message to the app updating the route for the next delivery. If this was the final delivery, a message is provided to the associate via the app. The system may also determine the route from the final delivery to the associate's end destination and present the route to the associate via the app.

In some configurations, the mobile device (such as a smartphone or tablet) used by the associate to accept offers and assist with delivery directions can belong to the store, whereas in other configurations the mobile device can be a personal device which belongs to the associate. For example, the associate may, in some configurations, sign up to receive delivery offers on their own smartphone, then be given a store-owned smartphone through which offers are received. In yet other configurations, the associate may register to deliver packages, receive package offers, and be guided to the delivery location via their personal mobile device.

In some configurations, the registration process can further comprise initiating a background check on the associate. When necessary, the backend/server can, based on that background check, offer distinct packages to the associate for delivery, or route that associate distinctly than other associates.

The system can perform these operations using a processor which is receiving inputs. For example, the processor may receive a constant stream of inputs associated with jobs, associate schedules/preferences/locations, data associated with delivery of the package through a third party, etc., and execute an algorithm to determine which store associates should receive offers to deliver the package. While in some cases the processor may be generic, single core processor which executes a single assembly code statement per clock execution, in other instances the processor can be a multi-core processor, which enables the algorithm to execute multiple statements in parallel.

In another configuration, the system can rely on a combination of the processing power of a server or other computing system coupled to the processing power of the processors on the mobile devices carried by the store associates. For example, the server can begin executing a portion of the algorithm, then send a query to the individual mobile devices of store associates located within a geographic radius. For a given mobile device, the query can cause the mobile device to perform a calculation necessary for the server's completion of the algorithm with respect to the store associate associated with the mobile device. In this scenario, if associate Bob wanted to be considered for delivery jobs, the server would send information or a query to Bob's mobile device about the package, its delivery location, delivery time required, etc. Bob's mobile device would then use Bob's preferences, circumstances (work schedule, physical ability, specialty), etc., and/or a confirmation from Bob of interest, to calculate a response to the server. This response could be a binary response (Yes, Bob qualifies for the job; No, Bob cannot do the job), or can be a non-binary response, such as a score from 1 to 10 indicating Bob's capacity for handling the job. The response would then be transmitted from Bob's mobile device to the server for comparison to data received from other store associates. This configuration (using the processing capacity of the mobile devices of the store associates) may result in faster overall computation by the server in determining which store associates should receive offers, and/or may result in power savings compared to the server storing and processing all the data used by the mobile devices.

Various embodiments of the disclosure are described in additional detail below. While specific implementations are described, it should be understood that this is done for illustration purposes only. Other components and configurations may be used without parting from the spirit and scope of the disclosure.

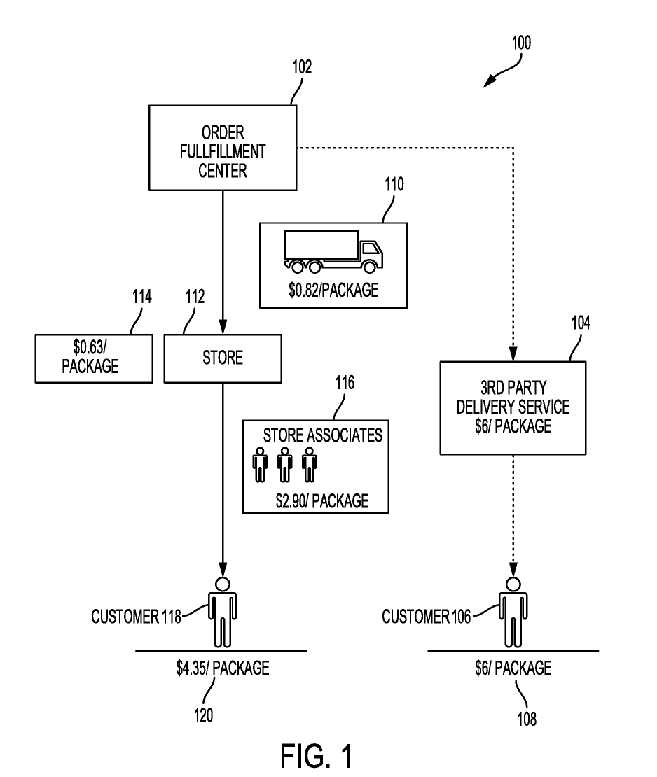

FIG. 1 illustrates exemplary cost savings 100 available through the disclosed concepts. More specifically, FIG. 1 illustrates estimated costs 108, 120 associated with delivering packages through third party delivery services versus allowing store associates to deliver packages while en route from work. First, a customer places an online order. That order is received by an order fulfillment center 102, which obtains the ordered item and packages the item for delivery. Using traditional third party delivery services 104, the exemplary cost to deliver the package from the fulfillment center 102 to the customer 106 is $6, resulting in a total cost to the vendor of $6, all of which is paid to the third party.

Using the concepts disclosed herein, the online vendor delivers the package from the fulfillment center 102 to a store 112 near the customer, then allows an associate to deliver the store 112 to the customer 118, rather than requesting the third party delivery services. In this example, the cost of shipping packages from the fulfillment center 102 to the store 112 is $0.82/package 110. The exemplary cost for associates at the store 112 to unload the truck (or other delivery vehicle) and place the packages into temporary storage costs $0.63/package 114. The cost of paying store associates to then deliver the package from the store 112 to the customer 118 is an exemplary $2.90/package, resulting in a total of $4.35/package for delivery via store associates. This $1.65 difference in cost has an added benefit of giving the money to store employees rather than to the third party services.

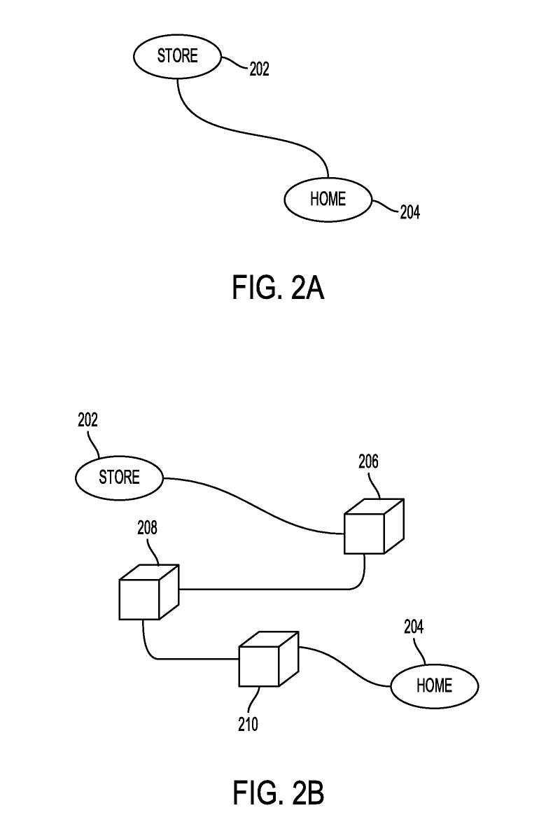

FIGS. 2A and 2B illustrate an exemplary delivery route an associate can take to delivery products while en route to their home. FIG. 2A illustrates the route an associate would take to travel directly from the store 202 to the associate's home 204. FIG. 2B illustrates the route an associate may take to get home 204 from the store 202 when dropping off packages at customer's homes 206, 208, 210. Systems configured as described herein (such as servers/backend processing or mobile devices) can provide routing information to the associate on how to arrive at the next destination. In some configurations, these systems can take into account local traffic conditions, effects the packages may have on fuel economy of the associate's vehicle, perishable time periods (such as when delivering milk or other perishable items), available help (i.e., where another associate may be routed to assist with the delivery of a package, then both associates meeting at the customer's delivery location to move a package to the door), and speed in completing all assigned deliveries.

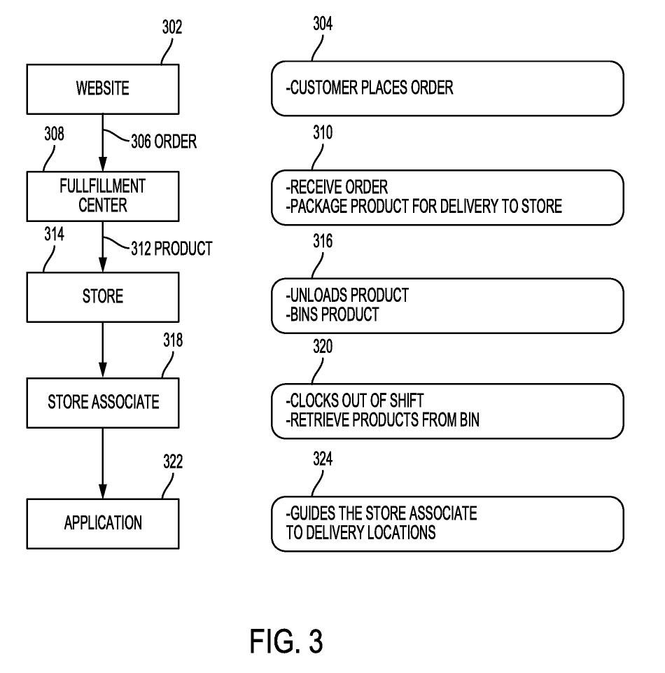

FIG. 3 illustrates exemplary stages of product fulfillment. In this example, the product fulfillment process begins when a customer places an order (304) through a website 302. The website 302 then transmits the order 306 to a fulfillment center 308. The fulfillment center 308 receives the order and packages a product for delivery to a store (310). The packaged product 312 is then shipped to a store 314, where associates unload the packaged product and place the packaged product into a bin (316) or other specific location within the store 314.

At this point, a server (or other computing system configured as disclosed herein) can send offers to associates of the store 314, the offers presenting information such as how much time delivering the package to a customer on the way home will add to the associate's commute, how much money the associate will earn by delivering the package, etc. When an associate 318 accepts the offer and finishes their shift at the store 314, the associate 318 clocks out of their shift and retrieves the package from the bin (or other storage location) where the package is being stored (320). The associate 318 is then guided (324) to the customer's location to deliver the package using an application (“app”) 322 on the associate's smartphone (or other mobile device).

If the associate 318 has signed up to deliver additional packages, the app 322 would, upon receiving confirmation that the first package is delivered, begin guiding the associate to the next destination associated with the next package. This would continue until all of the packages the associate has volunteered to deliver are delivered.

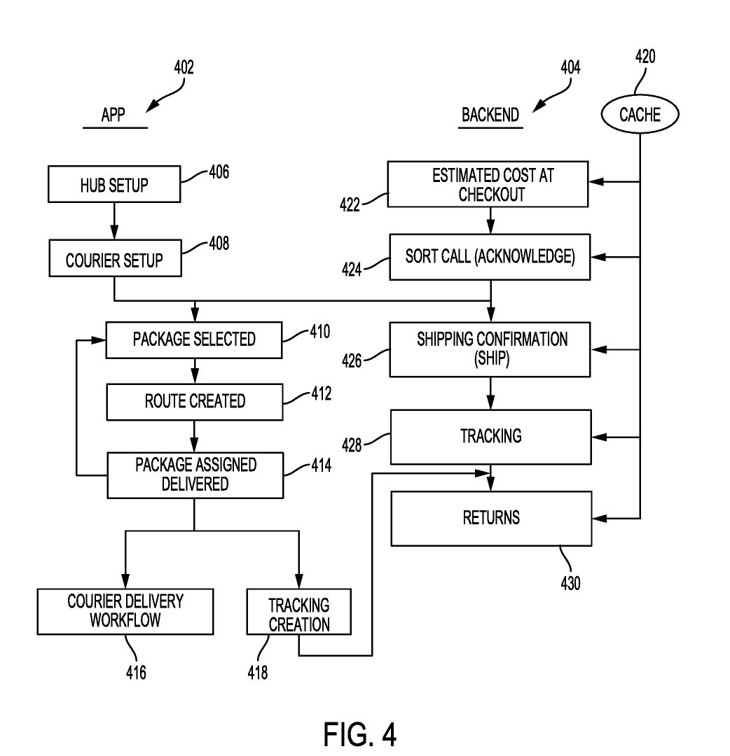

FIG. 4 illustrates exemplary processes being performed by an application (“app”) 402 operating on a mobile device as well as processes being performed simultaneously by backend computers 404 supporting the application. A cache 420 of information associated with an online delivery is also electronically available to the backend computer. This cache 420 can contain information such as the customer's name, address, the item being ordered, the cost of the order, information about delivery mechanisms, credit card information, and other information obtained from the website during the customer's online order.

The backend 404 computers receive information from the cache and can estimate a cost of the order at checkout 422. Using the estimated cost 422 and additional information from the cache 420, the backend 404 can generate a sort call (such as an acknowledge) initiating delivery of the package by either (1) delivery by an associate or (2) delivery by a third party delivery service. The sort call can use a rate table as a primary heuristic to determine cost of the package and to determine a primary and secondary delivery option to either exceed or meet the delivery date promised to the customer.

On the app 402 side, a hub is setup 406 which allows store associates to register to deliver packages from the store where they are employed. The hub 406 can act as a repository for information about associates who have volunteer to deliver packages. For example, the hub can store information about which stores are offering the service, which associates have signed up to deliver packages, and/or which products are suitable for associates to deliver. In addition, in some configurations the hub 406 can have access to the cache 420 of information associated with online orders.

The hub 406 can likewise facilitate the courier setup 408, or associate registration, process. For example, the courier setup 408 can allow an associate to enter information such as their home address (or where the associate typically travels to after work), the type of vehicle they use to travel to/from work, how much time they would have available to deliver packages, any weight/size restrictions the associate may have in moving packages, etc. If necessary, the courier setup 408 can likewise initiate background investigations or other requirements.

Once the associates have registered to deliver packages, an online order has been placed, and the sort call processed, the app 402 and the backend 404 operate in tandem to ensure the package is properly delivered. In one example, the app 402 presents packages which need to be delivered to associates who have registered for the program at the store nearest to the customer's location. If an associate volunteers to deliver the package, the app 402 assists in helping the associate make the delivery. The app 402 identifies a package selected 410 by the associate for delivery (or tells the associate which package will be delivered first). The app 402 then creates a route 412 for the associate to follow from their current location to the customer's location. In some configurations, the routes can be created 412 prior to the selection of an individual package 410, thereby allowing for the shortest overall delivery time required to deliver all assigned packages. The package assigned is then delivered by the associate 414, allowing the delivery process to repeat until all assigned packages have been delivered.

The app 402 sends the package delivery information to a courier delivery workflow 416 which tracks the associate's patterns of delivery. This information can include the associate's efficiency in delivering the packages, how often an associate delivers packages, feedback from customers regarding the associate's delivery, etc. In some configurations, this data can be used to offer delivery of certain packages to specific associates before offering the package to all registered associates, or to offer the associate extra bonuses or opportunities. The package delivery information can also be used in tracking creation 418, where the delivery information is reported to the backend 404.

In the event that the offer to deliver the package is not accepted by any of the associates in the store, the backend 404 can automatically arrange to ship the package via a third party delivery service. For example, if no associate has accepted the offer within a threshold amount of time prior to a desired delivery time, the backend 404 can initiate the shipping via the third party delivery service by sending the package information to the third party delivery service, then generating a shipping confirmation 426 when the third party delivery service picks up the package for delivery. Similarly, when an associate is delivering a package, once the associate retrieves the package for delivery, a shipping confirmation 426 can be generated by the backend 404, the shipping confirmation indicating that the package is out for delivery.

While the package is out for delivery (either by the third party delivery service or by an associate), the backend 404 can track the package location. In some cases, this can be done using GPS data from the mobile device operating the app being used by the store associate to deliver the package, and can provide a “street level” view of the package's current location. In other cases, the tracking can indicate that the package is currently out for delivery via the third party delivery service.

Once the package has been delivered, by the third party delivery service or the store associate, the backend 404 can enter the information associated with the package into a returns subsystem 430, where any returns which may be necessary can be managed and controlled.

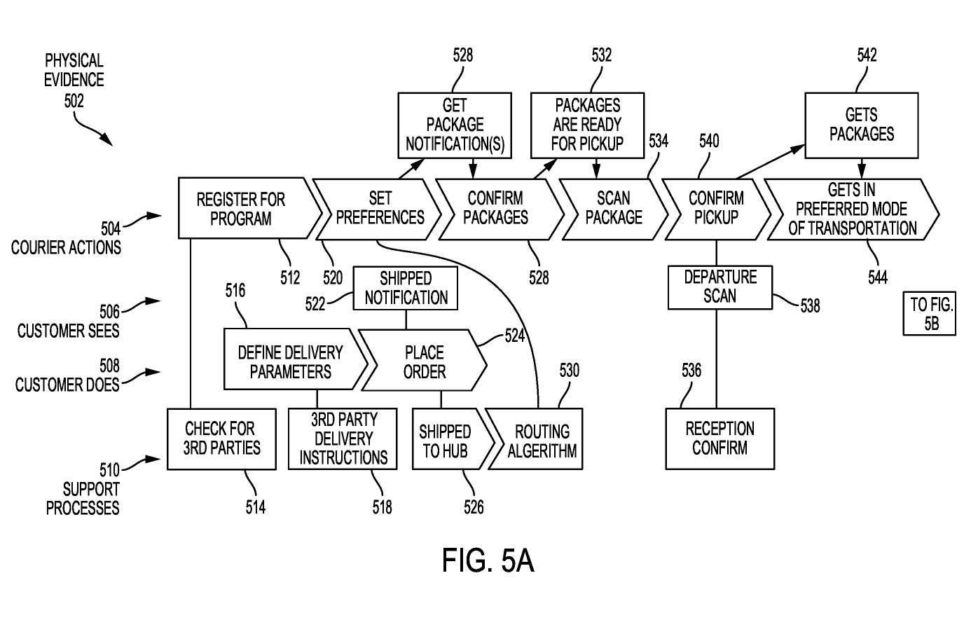

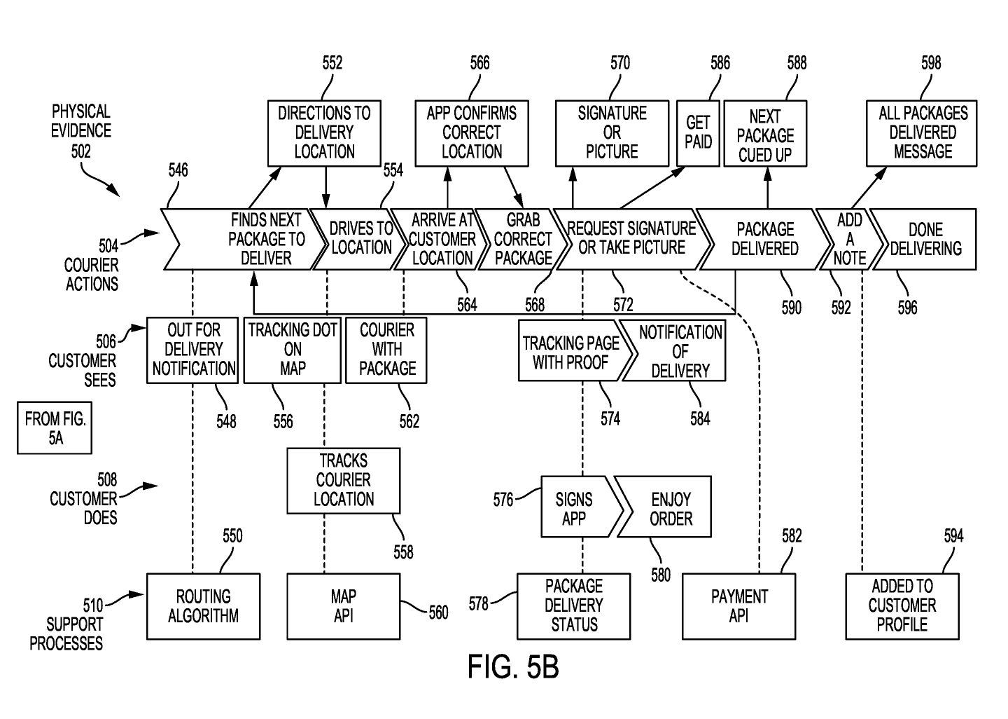

FIGS. 5A and 5B illustrate an exemplary flow chart of a successful delivery by a store associate according to the principles and concepts disclosed herein. In this example, there are five distinct rows identifying the processes and actions occurring. As illustrated, the processes and actions are distributed left-to-right, such that those items to the right occur after the items to the left of any given row. Moreover, the processes and actions are (generally) aligned vertically, such that items in two or more rows which share a common column occur either simultaneously or within close temporal proximity to one another. Where necessary for illustration, lines and/or arrows between columns are used to further identify order of actions. However, in some configurations, the order of operations or events can vary, or eliminate, specific steps illustrated.

The five rows 502, 504, 506, 508, 510 respectively illustrate physical evidence 502 (such where the package is located, notifications received via email, SMS/text messaging, obtaining the package, etc.), courier actions 504, what the customer sees 506, what the customer does 508, and what the support processes/backend computing services 510 are doing to support the delivery process.

Beginning with the associate registration, the store associate registers to be a courier by registering for the program 512, which can include setting preferences 520 such as how they travel to/from work, where they travel to (i.e., their home address), the size of packages they are willing to deliver, the weight of packages they are willing to deliver (of both individual packages and/or the aggregate of all packages being delivered by the associate), neighborhoods which the associate will not deliver to, specialty areas, etc. In some configurations, the associate may be tasked to install an item or otherwise perform a task at the customer location. In those configurations, the specialty areas of the associate can be helpful in identifying which potential couriers are qualified to perform the delivery/action. For example, the associate may be tasked with delivering and installing a television, in which case an associate with electronics experience may be desired. In another example, an associate may be tasked to deliver cookie dough to a customer's house and bake the cookies for the customer, in which case baking experience may be desired. As part of the registration process, the system can ask associates for areas of expertise. The registration process can also ask when the associate would be willing to deliver packages, and can link the associate's courier profile with the associate's work account, such that the support processes 510 are automatically have access to when the associate's shift begins and ends, when the associate will be working, etc. The support processes 510 can likewise identify third party availability 510 in the area near the courier's store.

To initiate the delivery of an item, the customer first defines delivery parameters 516 for an item, then places the order 524. The delivery parameters 516 can include information such as where the package should be delivered, how the package will be paid for, when the customer wants the package, etc. In cases where the option to deliver via local store associates is not available, the support processes 510 can check for third parties 514 to deliver the package. If a third party will be delivering the package, the support processes 510 can use the deliver parameters to generate third party delivery instructions 518 and initiate the delivery via the third party.

In cases where the support processes 510 identify a high likelihood that a store associate turned courier will volunteer to deliver the package, the package is shipped to the nearest hub or store 526 to the customer's delivery location. At this point, the customer is given a shipping notification 522 and the store couriers are presented with package notifications 528. The package notifications can come in the form of an email, a text message, an app notification, or other mechanism for providing notification to the registered couriers of packages which need to be delivered. These package notifications can be for packages which have arrived that day, online orders/packages which need to be delivered within a threshold time period (i.e., within the next three hours), packages associated with a specialty of the courier, etc. The notifications can serve as offers, informing the courier how much time would be required to deliver the package and/or how much the courier would be paid to perform the delivery. How long it would take to deliver the packages can be calculated by the support processes 510 performing a routing algorithm 530. The routing algorithm can calculate, based on current traffic conditions (or estimated future traffic conditions) (1) how long it would take the courier to travel home after their shift, (2) how much time would be added to the couriers trip home if they chose to deliver a package. The courier can select one or more of the packages for delivery by confirming the packages 528.

When the courier confirms that they will deliver a package 528, the support processes 510 can update the stored route home for the courier to include the drop-off location for the package, such that as the courier sees additional offers to deliver packages, the courier can be informed how much additional time the second, third, fourth, etc., packages would add to the courier's commute home.

During the courier's shift at the store, the courier can receive a notification that the packages are ready for pickup 532. When the courier ends their shift at the store, they can proceed to the storage bin where the packages are stored prior to be given to couriers for delivery. The courier, using their mobile device, can scan the packages 534 to identify that they have located the correct package. This scanning can include scanning a barcode, QR code, or other identifying code. Once the package is found, the courier confirms pickup 540 of the package. This confirmation can occur either using the app on their mobile device, or using a storage room scanner. The departure scan 538 is sent to the customer (allowing them to see that the package is now out for delivery) and to the support processes 510 (which confirm reception 536 of the scan). The courier then gets the packages 542 and gets in their preferred mode of transportation 544.

Moving to FIG. 5B, the routing algorithm 550 has generated the most efficient route for the courier to use to deliver the packages via a routing algorithm 550. The app on the courier's mobile device, communicates with the support processes 510 to identify which package is next for delivery and conveys to the courier which package is next 546. The customer sees 506 an “out for delivery” notification 548.

The support processes 510 then direct the courier to customer's location using a map API (Application Programming Interface), which are communicated to the app on the courier's mobile device, resulting in directions to the delivery location 552. The courier then drives to the location 554 while the customer can see a tracking dot on a map 556 and track the courier's location 558. As the courier arrives 564, the customer sees 506 the courier with the package 562. Meanwhile, the app confirms the current location as the correct location 566 for the package delivery. The courier grabs the correct package 568 and proceeds to the door of the customer's location.

The courier then presents the customer with the mobile device, requesting a signature 572 indicating delivery confirmation. The customer signs the app 576 and can, at the same time, be provided a tracking page with proof of delivery information 574. If the customer is not physically present to provide a signature, the courier can also take a picture 572. The customer signing the app, or the courier taking a picture of the delivered package, can trigger within the support processes 510 a package delivery status 578, thereby updating the support processes databases with the status of the package. The signature or picture 570 can be uploaded to the support processes and, in some configurations, forwarded to the customer as part of the notification of delivery 584. At this point, the customer enjoys the order 580 and the courier can be paid 586. A payment API 582 can similarly operate to finalize the customer's transaction/payment method. If the courier wishes to add a note 592 regarding any delivery, the app allows them to do so. This note can be, for example, added to a customer profile 594. For example, if a particular customer has a large dog, the courier may make a note of the dog so that a subsequent courier is informed beforehand.

With the package delivered 590, the next package is cued up 588 and the process of routing the courier to the delivery location of the next package 546, 554, 564, 568, 572 with associated backend processes and customer notifications is repeated. This continues until all of the packages assigned to the courier are delivered 596, at which point the courier can receive an “all packages delivered” message 598.

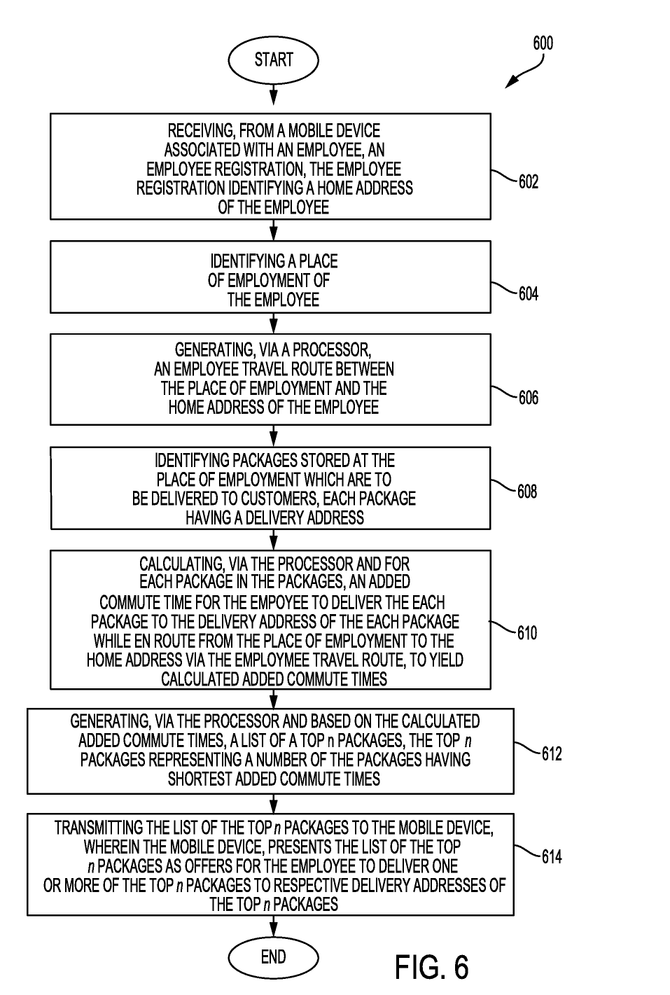

FIG. 6 illustrates an exemplary method 600 embodiment for practicing concepts disclosed herein. The exemplary method 600 illustrated can, for example, be practiced by a server or other computer system configured to have access to multiple types of information and databases. First, the system receives, from a mobile device associated with an employee, an employee registration, the employee registration identifying a home address of the employee (602). This registration process allows the employee to be a courier for packages being delivered from the store where the employee works. The system, from the registration process (602), identifies a place of employment of the employee (604) and generates, via a processor, an employee travel route between the place of employment and the home address of the employee (606).

The system then identifies packages stored at the place of employment which are to be delivered to customers, each package having a delivery address (608). The system calculates, via the processor and for each package in the packages, an added commute time for the employee to deliver the each package while en route from the place of employment to the home address of the employee via the employee travel route, to yield calculated added commute times (610). Based on the calculated added commute times, and via a processor, the system generates a list of a top n packages, the top n packages representing a number of the packages having shortest added commute times (612). The system then transmits the list of the top n packages to the mobile device, wherein the mobile device presents the list of the top n packages as offers for the employee to deliver one or more of the top n packages to respective delivery addresses of the top n packages (614).

In this example, the top n packages are identified based on the added commute times, however in other configurations the top n packages can be identified based on the amount of extra money the employee can earn by performing the delivery. In yet other configurations, multiple packages can be grouped together, and the group of packages can be offered to the employee. For example, if two or three packages are identified as having delivery locations within a given radius, the system can group those packages together and offer their deliveries as a group to employees. In some configurations, the list of the top n packages can reflect packages which can be delivered within an available time period. For example, if the employee indicates that they have an extra ten minutes while commuting home. In addition, in some configurations the list of the top n packages is further based on a specialty of the employee, such as electronics, food, etc.

In some configurations, the method can be further expanded to include: receiving, from the mobile device, a confirmation that the employee will deliver a specific package in the list of the top n packages; identifying remaining packages stored at the place of employment which are to be delivered to the customers, wherein the remaining packages are the packages not yet assigned a delivery mechanism; calculating, for each package in the remaining packages, an added commute time for the employee to deliver the each package to the delivery address of the each package while en route from the place of employment to the home address via an updated employee travel route, the updated employee travel route accounting for delivery of the specific package, to yield newly calculated added commute times; generating, based on the newly calculated added commute times, an updated list of top n packages, the updated list of top n packages representing a number of the remaining packages having shortest added commute times; and transmitting the updated list of top n packages to the mobile device, wherein the mobile device presents the updated list of top n packages as additional offers for the employee to deliver one or more packages to respective delivery addresses of the updated list of top n packages.

In yet other configurations, the method can be expanded to include transmitting, to the mobile device, navigation directions for the employee to follow while delivering a specific package in the top n packages. In this configuration, the navigation directions can be displayed as a map by the mobile device.

In this example, the place of employment can be, for example, a retail store. In other configurations, the employee may travel somewhere other than their home after work, and can register to deliver packages en route to that other location rather than their home. In these examples, the cost of delivery is less than that of a third party delivery service. In some configurations, the system can be further configured to automatically generate a third party delivery service request when a calculated cost for delivery of the package via a third party delivery service is less than a calculated cost for delivering the package

From the perspective of the mobile device, an exemplary method can include: receiving, on a mobile device associated with an employee, an employee registration for the employee, wherein the employee registration includes a home address of the employee; transmitting the employee registration to a server; receiving, from the server, a list of packages for delivery, the list of packages being based at least in part on distances from delivery destinations for packages in the list of packages from a route, the route being between a place of employment of the employee where the packages are stored and the home address; displaying, via the mobile device, the list of packages, wherein each package in the list of packages is displayed with a time required to deliver the package, a wage for delivering the package, a travel distance required to deliver the package, and an option to accept responsibility for delivering the package; receiving, at the mobile device, an input from the employee indicating a specific package in the list of packages which the employee will deliver; transmitting, from the mobile device to the server, the input; and receiving, from the server, an updated list of packages, wherein the updated list of packages is modified based on an updated route of the employee, the updated route reflecting delivery of the specific package by the employee while en route to the home address of the employee.

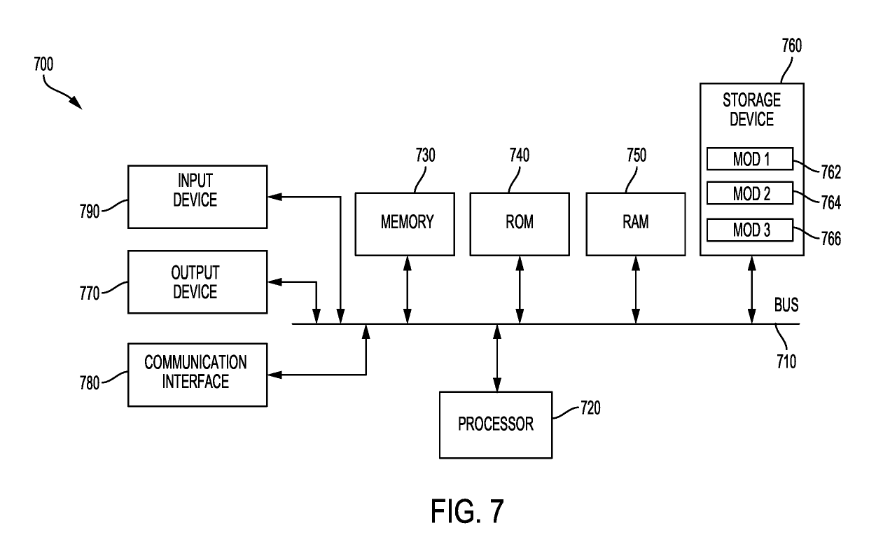

With reference to FIG. 7, an exemplary system 700 includes a general-purpose computing device 700, including a processing unit (CPU or processor) 720 and a system bus 710 that couples various system components including the system memory 730 such as read only memory (ROM) 740 and random access memory (RAM) 750 to the processor 720. The system 700 can include a cache of high speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, from a mobile device associated with an employee, an employee registration, the employee registration identifying a home address of the employee;
identifying a place of employment of the employee;
generating, via a processor, an employee travel route between the place of employment and the home address of the employee;
identifying packages stored at the place of employment which are to be delivered to customers, each package having a delivery address;
calculating, via the processor and for each package in the packages, an added commute time for the employee to deliver the each package to the delivery address of the each package while en route from the place of employment to the home address via the employee travel route, to yield calculated added commute times;
generating, via the processor and based on the calculated added commute times, a list of a top n packages, the top n packages representing a number of the packages having shortest added commute times; and
transmitting the list of the top n packages to the mobile device, wherein the mobile device presents the list of the top n packages as offers for the employee to deliver one or more of the top n packages to respective delivery addresses of the top n packages.

2. The method of claim 1, further comprising:
receiving, from the mobile device, a confirmation that the employee will deliver a specific package in the list of the top n packages;
identifying remaining packages stored at the place of employment which are to be delivered to the customers, wherein the remaining packages are the packages not yet assigned a delivery mechanism;
calculating, for each package in the remaining packages, an added commute time for the employee to deliver the each package to the delivery address of the each package while en route from the place of employment to the home address via an updated employee travel route, the updated employee travel route accounting for delivery of the specific package, to yield newly calculated added commute times;
generating, based on the newly calculated added commute times, an updated list of top n packages, the updated list of top n packages representing a number of the remaining packages having shortest added commute times; and
transmitting the updated list of top n packages to the mobile device, wherein the mobile device presents the updated list of top n packages as additional offers for the employee to deliver one or more packages to respective delivery addresses of the updated list of top n packages.

3. The method of claim 1, further comprising:
transmitting, to the mobile device, navigation directions for the employee to follow while delivering a specific package in the top n packages.

4. The method of claim 3, wherein the navigation directions are displayed as a map by the mobile device.

5. The method of claim 1, wherein the list of the top n packages reflects packages which can be delivered within an available time period.

6. The method of claim 1, wherein the list of the top n packages is further based on a specialty of the employee.

7. The method of claim 1, wherein a cost of delivery by the employee is less than that of a third party delivery service.

8. The method of claim 1, wherein the place of employment is a retail store.

9. A system comprising:
a processor; and
a computer-readable storage medium having instructions stored which, when executed by the processor, cause the processor to perform operations comprising:
receiving, on a mobile device associated with an employee, an employee registration for the employee, wherein the employee registration includes a home address of the employee;
transmitting the employee registration to a server;
receiving, from the server, a list of packages for delivery, the list of packages being based at least in part on distances from delivery destinations for packages in the list of packages from a route, the route being between a place of employment of the employee where the packages are stored and the home address;
displaying, via the mobile device, the list of packages, wherein each package in the list of packages is displayed with a time required to deliver the package, a wage for delivering the package, a travel distance required to deliver the package, and an option to accept responsibility for delivering the package;
receiving, at the mobile device, an input from the employee indicating a specific package in the list of packages which the employee will deliver;
transmitting, from the mobile device to the server, the input; and
receiving, from the server, an updated list of packages, wherein the updated list of packages is modified based on an updated route of the employee, the updated route reflecting delivery of the specific package by the employee while en route to the home address of the employee.

10. The system of claim 9, the computer-readable storage medium having additional instructions which, when executed by the processor, cause the processor to perform operations comprising:
displaying, via the mobile device, a map illustrating navigation directions for the employee to follow while delivering the specific package.

11. The system of claim 10, wherein the navigation directions are received by the mobile device from the server.

12. The system of claim 9, the computer-readable storage medium having additional instructions which, when executed by the processor, cause the processor to perform operations comprising:
receiving, at the mobile device, an available time period in which the employee can deliver packages,
wherein the list of packages reflects packages which can be delivered within the available time period.

13. The system of claim 9, wherein the list of packages is further based on a specialty of the employee.

14. The system of claim 9, wherein a cost of delivery by the employee is less than that of a third party delivery service.

15. The system of claim 9, wherein the place of employment is a retail store.

16. A non-transitory computer-readable storage device having instructions stored which, when executed by a computing device, cause the computing device to perform operations comprising:
receiving, from a mobile device associated with an employee, an employee registration, the employee registration identifying a home address of the employee;
identifying a place of employment of the employee;
generating an employee travel route between the place of employment and the home address of the employee;
identifying packages stored at the place of employment which are to be delivered to customers, each package having a delivery address;
calculating, for each package in the packages, an added commute time for the employee to deliver the each package to the delivery address of the each package while en route from the place of employment to the home address via the employee travel route, to yield calculated added commute times;
generating, based on the calculated added commute times, a list of a top n packages, the top n packages representing a number of the packages having shortest added commute times; and
transmitting the list of the top n packages to the mobile device, wherein the mobile device presents the list of the top n packages as offers for the employee to deliver one or more of the top n packages to respective delivery addresses of the top n packages.

17. The non-transitory computer-readable storage device of claim 16, having additional instructions stored which, when executed by the computing device, cause the computing device to perform operations comprising:
receiving, from the mobile device, a confirmation that the employee will deliver a specific package in the list of the top n packages;
identifying remaining packages stored at the place of employment which are to be delivered to the customers, wherein the remaining packages are the packages not yet assigned a delivery mechanism;
calculating, for each package in the remaining packages, an added commute time for the employee to deliver the each package to the delivery address of the each package while en route from the place of employment to the home address via an updated employee travel route, the updated employee travel route accounting for delivery of the specific package, to yield newly calculated added commute times;
generating, based on the newly calculated added commute times, an updated list of top n packages, the updated list of top n packages representing a number of the remaining packages having shortest added commute times; and
transmitting the updated list of top n packages to the mobile device, wherein the mobile device presents the updated list of top n packages as additional offers for the employee to deliver one or more packages to respective delivery addresses of the updated list of top n packages.

18. The non-transitory computer-readable storage device of claim 16, having additional instructions stored which, when executed by the computing device, cause the computing device to perform operations comprising:
transmitting, to the mobile device, navigation directions for the employee to follow while delivering a specific package in the top n packages.

19. The non-transitory computer-readable storage device of claim 18, wherein the navigation directions are displayed as a map by the mobile device.

20. The non-transitory computer-readable storage device of claim 16, wherein the list of the top n packages reflects packages which can be delivered within an available time period.
